(19) United States
(12) Patent Application Publication
(10) Pub. No.: US 2026/0186220 A1
(43) Pub. Date: Jul. 2, 2026

(54) OPTICAL ELEMENT FIXATION STRUCTURE

(71) Applicant: Accelink Technologies Co., Ltd., Wuhan, Hubei (CN)

(72) Inventors: Beili SONG, Wuhan, Hubei (CN); Mengyang SONG, Wuhan, Hubei (CN); Benqing QUAN, Wuhan, Hubei (CN); Deling ZHANG, Wuhan, Hubei (CN)

(73) Assignee: Accelink Technologies Co., Ltd., Wuhan, Hubei (CN)

(21) Appl. No.: 18/857,998

(22) PCT Filed: Jul. 13, 2022
(86) PCT No.: PCT/CN2022/105425

§ 371 Date: Oct. 18, 2024

(30) Foreign Application Priority Data
Apr. 21, 2022 (CN) 202210419818.1

(51) Int. Cl. G02B 6/42

(52) U.S. Cl. CPC G02B 6/4277; G02B 6/4228; G02B 6/4244; G02B 6/4256

(57) ABSTRACT

An optical element (12) fixation structure, comprising: a module housing (10), a fixation body (111), a first fixation unit (112), a second fixation unit (113), a third fixation unit (114), and an elastic fixation unit (115), wherein the first fixation unit (112) is used for fixing a first end (131) of an optical fiber connector and a first end (121) of an optical element to a first end (1111) of the fixation body in a snap-fit manner, the second fixation unit (113) is used for fixing a second end (132) of the fiber optic connector and a second end (122) of the optical element to a second end (1112) of the fixation body in an attaching manner, and the third fixation unit (114) is used for fixing side edges of the optical element (12) to both sides of the fixation body (111). The optical element (12) fixation structure fixes the fiber optic connector (13) and the optical element (12) by means of an ingenious structural fitting between the optical element (12) fixation structure and both of the fiber optic connector (13) and the optical element (12) without assistance of other parts, which simplifies the components of the optical element (12) fixation structure, and meanwhile achieves more convenient installation and disassembly.

### TECHNICAL FIELD OF THE DISCLOSURE

The present disclosure relates to the field of optical element fixation, and in particular, to an optical element fixation structure.

### BACKGROUND

Optical modules are responsible for photoelectric signal conversion, occupying a basic and key position in the optical communication industry, and being closely related to the life of people. Along with the rapid development of the information technology industry, the rapid increase of data traffic, and the ever-increasing demand for optical modules in global communication system, higher requirements are put forward for optical modules in the aspects of reliability, electromagnetic compatibility, and maintainability and the like.

Optical elements (e.g. lenses, etc.) are located in an optical module and play an important role in the photoelectric signal conversion process. The optical elements must be reliably connected with optical fibers and circuit boards so as to ensure stable transmission of photoelectric signals. There are two primary modes for fixing optical elements and optical fibers in the prior art: the first one is to glue optical fiber connectors and the optical elements together, and the defect of this mode is that when a fault occurs in an optical module, it cannot be repaired, and then the optical fibers, optical elements, and circuit board can only be scrapped together; and the second one is that an optical fiber connector and an optical element are sleeved together with a plastic ferrule, which improves the maintainability of the optical module product compared with the first mode; however, due to the fact that the electromagnetic radiation of the photoelectric chip under the optical element is large, it is generally necessary to additionally install a metal shielding cover to prevent electromagnetic leakage, while the plastic ferrule occupies a narrow space inside the optical module, then there is already no space for installing a metal shielding cover, which greatly reduces the electromagnetic compatibility of the optical module.

### SUMMARY

In view of this, the present disclosure provides an optical element fixation structure, and making an optical element and an optical fiber connector be performed all-round localization in an attaching mode or snap-fit mode, solves the problem that, in the prior art an optical module cannot be repaired when a fault occurs.

In order to achieve one or part or all of the above-mentioned purposes or other purposes, the present disclosure provides an optical element fixation structure, which is used for fixing an optical element and an optical fiber connector, the optical element be provided with a front-end socket, the optical fiber connector being provided in the optical element through the front-end socket, and the optical element fixation structure comprises:
a module housing which comprises an upper housing and a lower housing;
a fixation body which is provided in the module housing;
a first fixation unit 112 which is provided at a first end of the fixation body, and is used for fixing a first end of the optical fiber connector and a first end of the optical element to the first end of the fixation body in a snap-fit manner;
a second fixation unit which is provided at a second end of the fixation body, and is used for fixing a second end of the optical fiber connector and a second end of the optical element to the second end of the fixation body in an attaching manner;
a third fixation unit which is provided at side edges of the fixation body, and is used for fixing side edges of the optical element to both sides of the fixation body in a snap-fit manner.

In the optical element fixation structure of the present disclosure, the optical element fixation structure is a metal piece.

In the optical element fixation structure of the present disclosure, the second fixation unit comprises a first connection portion used for connecting other components and a clip-clasp portion used for being fixed with the optical fiber connector in an attaching manner; and
the clip-clasp portion and the first connection portion are provided in a bent manner, and the clip-clasp portion is located on a side close to the second end of the fixation body.

In the optical element fixation structure of the present disclosure, the optical element fixation structure comprises an elastic fixation unit provided between the fixation body and the upper housing, and the elastic fixation unit is used for defining a degree of freedom of the optical element and the optical fiber connector in an up and down direction.

In the optical element fixation structure of the present disclosure, the elastic fixation unit comprises an elastic connection portion for connecting with the first connection portion, which is provided at an acute angle with the first connection portion.

In the optical element fixation structure of the present disclosure, the elastic fixation unit 115 is a wavy metal piece.

In the optical element fixation structure of the present disclosure, the elastic fixation unit comprises a body connection portion for connecting the fixation body, an elastic attaching portion for fixing with the fixation body in an attaching manner, and a second elastic compression portion for connecting the body connection portion and the elastic attaching portion;
the body connection portions are symmetrically provided on both sides of the fixation body;
the second elastic compression portions are symmetrically provided above the fixation body.

In the optical element fixation structure of the present disclosure, the elastic fixation unit comprises a body connection portion for connecting the fixation body, an elastic attaching portion for fixing with the fixation body in an attaching manner, and a second elastic compression portion for being provided in cooperation with the upper housing;
the body connection portions are symmetrically provided on both sides of the fixation body;
the elastic attaching portions are symmetrically provided above the fixation body, and are connected with the body connection portion and the second elastic compression portion.

In the optical element fixation structure of the present disclosure, the first fixation unit is provided with an opening for accommodating the optical fiber, both sides of which opening are respectively provided with a stuck point, and a corresponding position of the first end of the optical fiber connector is provided with a stuck hole, through which and stuck point the optical fiber connector is fixed to the first fixation unit in a snap-fit manner.

In the optical element fixation structure of the present disclosure, the third fixation unit is provided with a snap-fit portion, and both sides of the optical element are respectively provided with a clamping slot portion corresponding to the snap-fit portion; and the optical element is fixed to the third fixation unit through the snap-fit portion and the clamping slot portion in a snap-fit manner.

Compared with the prior art, the beneficial effects of the present disclosure are as follows: in the present embodiment, the first fixation unit of the optical element fixation structure fixes the first end of the optical element and the first end of the optical fiber connector; the second fixation unit fixes the second end of the optical element and the second end of the optical fiber connector; the third fixation unit is matched with the module housing to fix an upper end face and a lower end face of the optical element and the optical fiber connector; the elastic fixation unit fixes both sides of the optical element and the optical fiber connector. That is, the optical element fixation structure positions the optical element and the optical fiber connector through the first fixation unit, the second fixation unit, the third fixation unit and the elastic fixation unit, enhancing the stability of the connection between the optical element and the optical fiber connector, and improving the stability of photoelectric signal transmission.

And when the optical element fixation structure is a metal piece, it is equivalent to using a component of metal material to wrap a photoelectric chip, so that the effect of additionally installing a metal shielding cover is achieved, the leakage is reduced, and the electromagnetic radiation located below the optical element can be effectively blocked, whereby the electromagnetic compatibility of the optical module is improved.

### BRIEF DESCRIPTION OF THE DRAWINGS

In order to more clearly explain the embodiments of the present disclosure or the technical solutions in the prior art, the drawings required in the embodiments or the description of the prior art are briefly introduced in the followings, obviously, the drawings in the following description are some embodiments of the present disclosure, and for those skilled in the art, other drawings may be obtained according to these drawings without any inventive labor.

FIG. 1 is a first schematic structural diagram of an optical element fixation structure according to an embodiment of the present disclosure.

FIG. 2 is a second schematic structural diagram of an optical element fixation structure according to an embodiment of the present disclosure.

FIG. 3 is a third schematic structural diagram of an optical element fixation structure according to an embodiment of the present disclosure.

FIG. 4 is a fourth schematic structural diagram of an optical element fixation structure according to an embodiment of the present disclosure.

FIG. 5 is a schematic structural diagram of a first angle of an optical element fixer in FIG. 1.

FIG. 6 is a schematic structural diagram of a second angle of an optical element fixer in FIG. 1.

FIG. 7 is a side view of an optical element fixer in FIG. 1.

FIG. 8 is an assembly schematic diagram of an optical element fixation structure in FIG. 1.

FIG. 9 is another schematic structural diagram of an optical element fixer.

FIG. 10 is an oblique view of an optical element fixer in FIG. 9.

FIG. 11 is a side view of an optical element fixer in FIG. 9.

FIG. 12 is an assembly schematic diagram of an optical element fixer in FIG. 9 applied to an optical element fixation structure.

FIG. 13 is another schematic structural diagram of an optical element fixer.

FIG. 14 is a schematic structural diagram of an optical element fixer in FIG. 13.

FIG. 15 is a side view of an optical element fixer in FIG. 13.

FIG. 16 is an assembly schematic diagram of an optical element fixer in FIG. 13 applied to an optical element fixation structure.

In the figures:
10 Module housing
101 Upper housing
102 Lower housing
11 Optical element fixer
111 Fixation body
1111 First end of a fixation body
1112 Second end of a fixation body
112 First fixation unit
1121 Opening
1122 Stuck point
113 Second fixation unit
1131 First connection portion
1132 Clip-clasp portion
114 Third fixation unit
1141 Snap-fit portion
115 Elastic fixation unit
1151 First elastic compression portion
1152 Elastic connection portion
1153 Body connection portion
1154 Second elastic compression portion
1155 Elastic attaching portion
12 Optical element
121 First end of an optical element
122 Second end of an optical element
123 Clamping slot portion
13 Optical fiber connector
131 First end of an optical fiber connector
132 Second end of an optical fiber connector
133 Stuck hole
14 Optical fiber
15 Circuit board

### DETAILED DESCRIPTION

In the description of the present disclosure, the orientation or position relationship indicated by the terms “inner”, “outer”, “longitudinal”, “lateral”, “upper”, “lower”, “top”, “bottom” and the like is based on the orientation or positional relationship shown in the drawings, which is only for the purpose of describing the present disclosure rather than requiring the present disclosure must be constructed and operated in a specific orientation, and which should not be understood as a limitation to the present disclosure.

The technical solutions in the embodiments of the present disclosure will be clearly and completely described below in conjunction with the accompanying drawings in the embodiments of the present disclosure; and obviously, the described embodiments are merely a part of the embodiments of the present disclosure, but not the whole embodiments the present disclosure. Based on the embodiments of the present disclosure, all other embodiments obtained by those skilled in the art without inventive labor shall fall within the protection scope of the present disclosure.

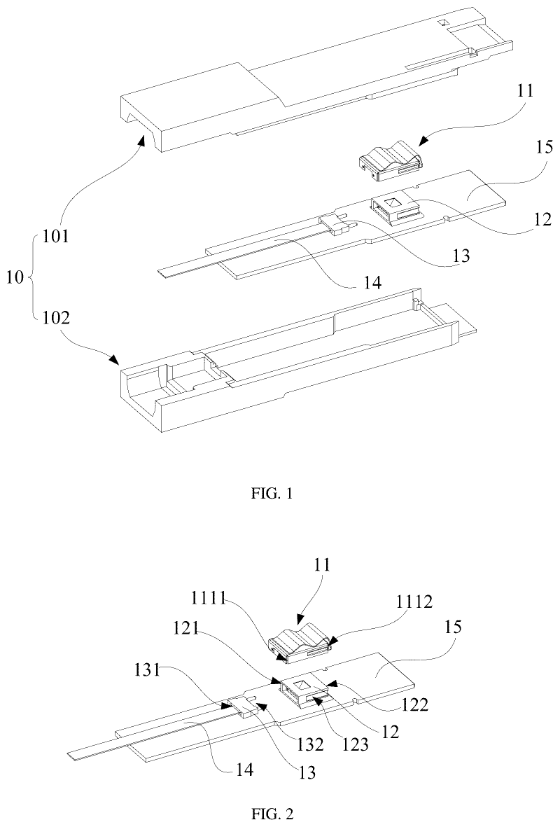

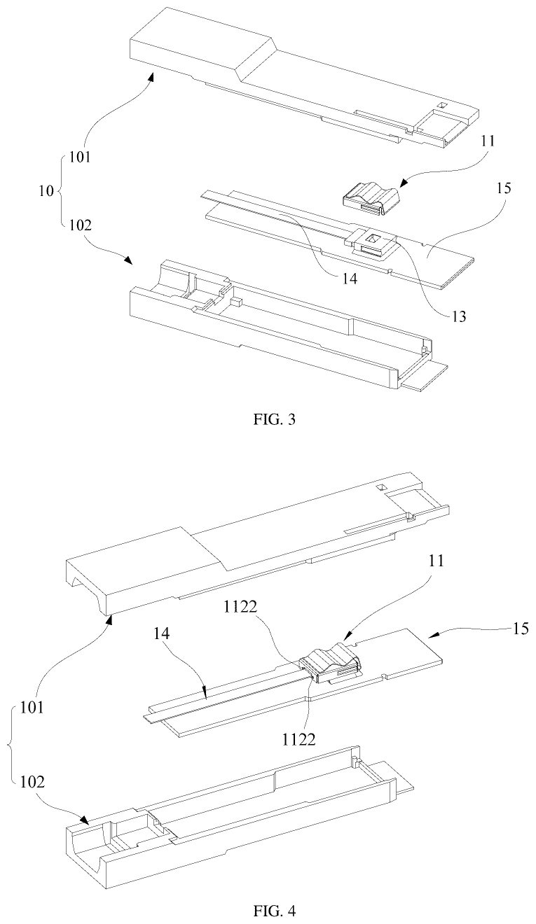

Referring to FIG. 1 to FIG. 4, a fixation structure for an optical element 12 provided in the present disclosure is used for matching with a module housing 10, and fixing the optical element 12 and an optical fiber connector 13, wherein the fixation structure for the optical element 12 comprises the module housing 10 and an optical element fixer 11, and the optical element fixer 11 comprises a fixation body 111, a first fixation unit 112, a second fixation unit 113, a third fixation unit 114 and an elastic fixation unit 115. In the present disclosure, the optical fiber connector 13 is provided in the optical element 12, and the optical element 12 is located in the fixation structure for the optical element 12. Specifically, in the present disclosure, the optical element 12 is provided with a front-end socket, a first end 131 of the optical fiber connector being provided with a pin, and the optical element 12 is coupled and bonded with a circuit board 15 to form a whole, then, the optical fiber connector 13 connected with an optical fiber 14 is inserted into the front-end socket of the optical element 12, and the optical fiber connector 13 is ensured to be in connected with the optical element 12 through the pin, so as to make the optical fiber connector 13 be located in the optical element 12, and then, the optical element 12 and the optical fiber connector 13 are fixed in the optical element fixer 11, and the optical element fixer 11 is provided in the module housing 10, thereby playing a role of further fixing.

Referring to FIG. 1 to FIG. 4, one embodiment of the present disclosure provides a fixation structure for an optical element 12, which is used for fixing an optical element 12 and an optical fiber connector 13, wherein the optical element 12 is provided with a front-end socket, and the optical fiber connector 13 is provided in the optical element 12 through the front-end socket, and the fixation structure for the optical element 12 comprises: a module housing 10, a fixation body 111, a first fixation unit 112, a second fixation unit 113, a third fixation unit 114 and an elastic fixation unit 115.

The fixation body 111 is set in the module housing 10.

The first fixation unit 112 is set at a first end 1111 of the fixation body and is used for fixing a first end 131 of the optical fiber connector and a first end 121 of the optical element to the first end 1111 of the fixation body in a snap-fit manner.

The second fixation unit 113 is set at a second end 1112 of the fixation body and is used for fixing a second end 132 of the optical fiber connector and a second end 122 of the optical element to the second end 1112 of the fixation body in an attaching manner.

The third fixation unit 114 is set at side edges of the fixation body 111 and is used for fixing side edges of the optical element 12 to both sides of the fixation body 111.

In the present embodiment, a localization is performed by the fixation structure for the optical element 12 to the optical fiber connector 13 and the optical element 12 through the following mode, i.e. setting the first fixation unit 112, which is used for fixing the first end 131 of the optical fiber connector and the first end 121 of the optical element to the first end 1111 of the fixation body in a snap-fit manner, setting the second fixation unit 113, which is used for fixing the second end 132 of the optical fiber connector and the second end 122 of the optical element to the second end 1112 of the fixation body in an attaching manner, and setting the third fixation unit 114, which is used for fixing side edges of the optical element 12 to both sides of the fixation body 111 in a snap-fit manner, which improves the stability of the fixation between the optical fiber connector 13 and the optical element 12, and enhances the stability of photoelectric signal transmission under severe conditions such as impact or vibration. And the fixation structure for the optical element 12 is fixed to the optical element 12 and the optical fiber connector 13 in a snap-fit manner or in an attaching manner; that is, the fixation structure for the optical element 12 fixes the fiber optic connector 13 and the optical element 12 only by means of an ingenious structural fitting between the fixation structure for the optical element 12 and both of the fiber optic connector 13 and the optical element 12 without assistance of other parts, which simplifies the structure of the fixation structure for the optical element 12, meanwhile, is more convenient when performing installation and disassembly.

Since the optical fiber connector 13 and the optical element 12 can be conveniently assembled and disassembled, when a fault occurs in the optical module, the optical fiber connector 13 and the optical element 12 can be disassembled in time to perform the fault troubleshooting, and after the faulty element is found out, replacement or maintenance can be performed in a targeted mode, whereby the optical fiber 14 and the optical element 12 do not need to be scrapped together, and then the cost is saved. Moreover, the setting that the optical fiber connector 13 and the optical element 12 are convenient to be disassembled, also improves the efficiency and precision of troubleshooting, and is also convenient for the research and development personnel and production personnel to analyze the cause of such faults, and the ability to avoid such faults has been improved.

In the present embodiment, the first fixation unit 112 of the fixation structure for the optical element 12 fixes the first end 121 of the optical element and the first end 131 of the optical fiber connector. The second fixation unit 113 fixes the second end 122 of the optical element and the second end 132 of the optical fiber connector. The third fixation unit 114 is matched with the module housing 10 to fix an upper end face and a lower end face of the optical element 12 and the optical fiber connector 13. The elastic fixation unit 115 fixes both sides of the optical element 12 and the optical fiber connector 13. That is, the fixation structure for the optical element 12 performs all-round localization for the optical element 12 and the optical fiber connector 13 through the first fixation unit 112, the second fixation unit 113, the third fixation unit 114 and the elastic fixation unit 115, enhancing the stability of the connection between the optical element 12 and the optical fiber connector 13, and improving the stability of photoelectric signal transmission.

Referring to FIG. 1 to FIG. 4, in one embodiment, the fixation structure for the optical element 12 is a metal piece; that is, the fixation structure for the optical element 12 is made of a metal material. In the present embodiment, a circuit board 15 having a photoelectric chip is provided below the optical element 12, the optical element 12 is coupled and bonded with the circuit board 15 to form a whole, then, the optical fiber connector 13 connected with the optical fiber 14 is inserted into the front-end socket of the optical element 12, and it is fixed through the fixation structure for the optical element 12. When the fixation structure for the optical element 12 is a metal piece, it is equivalent to using a component made of a metal material to wrap the photoelectric chip, so that the effect of additionally installing a metal shielding cover is achieved, the leakage is reduced, and the electromagnetic radiation located below the optical element 12 can be effectively blocked, thereby improving the electromagnetic compatibility of the optical module.

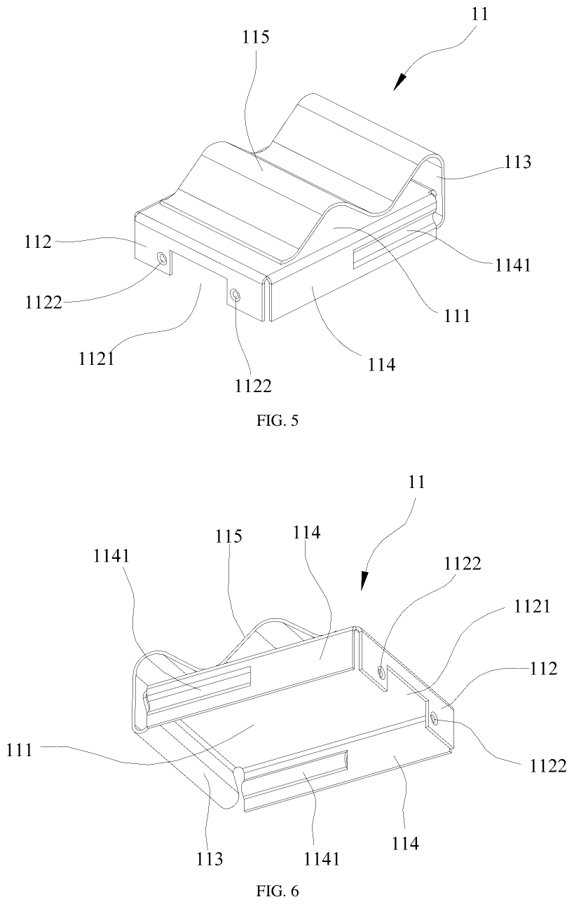

Referring to FIG. 5 to FIG. 8, in one embodiment, the second fixation unit 113 comprises a first connection portion 1131 used for connecting other components and a clip-clasp portion 1132 used for being fixed with the optical fiber connector 13 in an attaching manner.

The clip-clasp portion 1132 and the first connection portion 1131 are set in a bent manner, and the clip-clasp portion 1132 is located on a side close to the second end 1112 of the fixation body.

When the clip-clasp portion 1132 and the optical fiber connector 13 are not provided in the optical element fixer 11, a distance L1 between the clip-clasp portion 1132 and the first fixation unit 112 is smaller than or equal to a distance L2 between the first end 1111 of the fixation body and the second end 1112 of the fixation body; that is, L1 is ≤L2.

When the clip-clasp portion 1132 and the optical fiber connector 13 are provided in the optical element fixer 11, the distance L1 between the clip-clasp portion 1132 and the first fixation unit 112 is greater than or equal to the distance L2 between the first end 1111 of the fixation body and the second end 1112 of the fixation body, that is, L1≥L2.

In the present embodiment, after the optical element 12 and the optical fiber connector 13 are placed in the optical element fixer 11, the distance L1 between the clip-clasp portion 1132 and the first fixation unit 112 is supported by the optical element 12 and the optical fiber connector 13 and become larger, so that the clip-clasp portion 1132 and both the second end 132 of the optical fiber connector and the second end 122 of the optical element generate interaction force, and the clip-clasp portion 1132 is fixed to the second end 132 of the optical fiber connector and the second end 122 of the optical element in an attaching manner, so that the optical element 12 and the optical fiber connector 13 in the optical element fixer 11 are more stably connected. It should be pointed out that the second fixation piece has certain elastic characteristics and has the ability to restore the original shape after being subjected to a certain acting force, and when being subjected to severe environments such as impact or oscillation, the stability of the connection between the optical element 12 and the optical fiber connector 13 can be kept due to having certain elastic characteristics.

Referring to FIG. 5, in one embodiment, the fixation structure for the optical element 12 comprises an elastic fixation unit 115 provided between the fixation body 111 and the upper housing 101, and the elastic fixation unit 115 is used for defining a degree of freedom of the optical element 12 in an up and down direction. In the present embodiment, the fixation structure for the optical element 12 fixes the two ends of the optical fiber connector 13 and the optical element 12 through the first fixation unit 112 and the second fixation unit 113 respectively, fixes the two sides of the optical element 12 through the second fixation unit 113, and defines the degree of freedom of the optical element 12 in the up and down direction through the elastic fixation unit 115, so that a connector for the optical fiber 14 connector and the optical element 12 are defined in all directions, whereby the photoelectric signal of the optical module can be stably transmitted under severe conditions such as impact and vibration, and the stability and reliability of photoelectric signal transmission are improved.

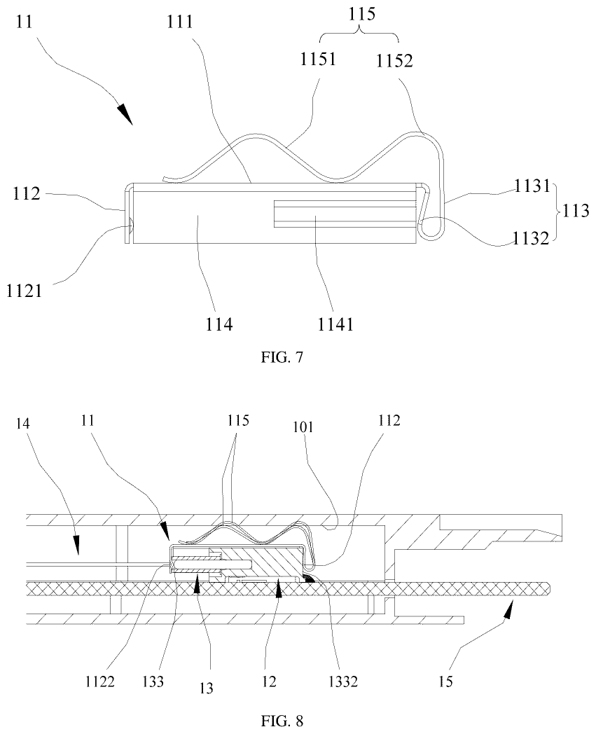

Referring to FIG. 7 and FIG. 8, in one embodiment, the elastic fixation unit 115 comprises an elastic connection portion 1152 for connecting with the first connection portion 1131 and a first elastic compression portion 1151 attached to the upper housing 101. The elastic connection portion 1152 and the first connection portion 1131 are set at an acute angle. When the upper housing 101 and the lower housing 102 are closed, the elastic fixation unit 115 located between the fixation body 111 and the upper housing 101 is extruded and deformed, the first elastic compression portion 1151 is in a compressed state, the first elastic compression portion 1151 is compressed between the optical element 12 and the upper housing 101 and is attached with the optical element 12. Since the elastic connection portion 1152 and the first connection portion 1131 are provided at an acute angle, when the first elastic compression portion 1151 is compressed, the first elastic compression portion 1151 generates a horizontal component force which is horizontal for the second fixation unit 113 through the elastic connection portion 1152 and directs to the first end of the fixation body 1111, thereby increasing the attaching strength between the clip-clasp portion 1132 and both the second end 132 of the optical fiber connector and the second end 122 of the optical element, improving the stability and reliability of the fixation of the connector for the optical fiber 14 and the optical element 12, and improving the stability that the photoelectric signal of the optical module can be transmitted under severe conditions such as impact, vibration.

Referring to FIG. 7, in one embodiment, the elastic fixation unit 115 may be a wavy metal piece. In the present embodiment, after the upper housing 101 and the lower housing 102 are closed, the elastic fixation unit 115 is extruded and deformed, the upper housing 101 presses down towards the elastic fixation unit 115, and then the upper housing 101 applies an acting force on the elastic fixation unit towards the lower housing 102, so that the elastic fixation unit 115 is in a compressed state. At this time, the elastic fixation unit 115 will apply an acting force to the fixation body 111 towards the lower housing 102, enabling the fixation body 111 to be tightly attached with the optical element 12, and then enabling the optical element 12 to be tightly attached with the optical fiber connector 13. When being subjected to severe environments such as impact or oscillation, the stable connection between the optical element 12 and the optical fiber connector 13 can also be maintained because the elastic fixation unit 115 has a function of buffering and vibration absorption.

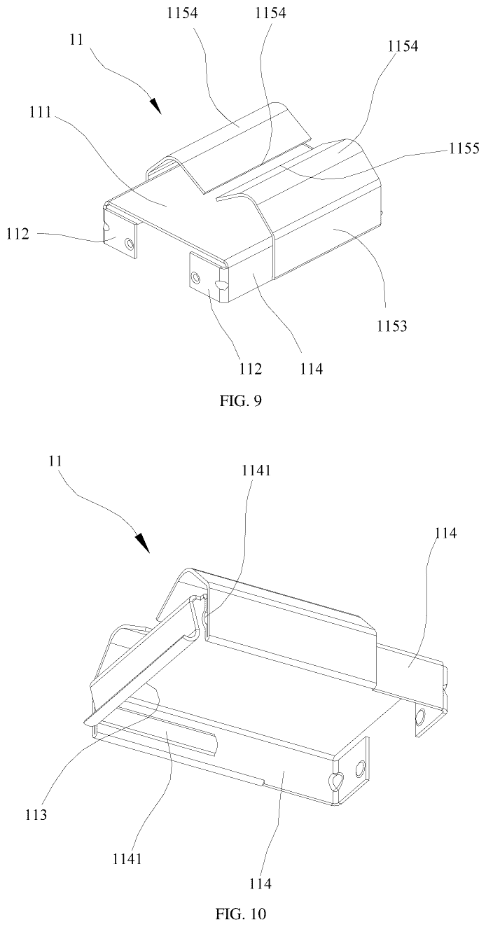

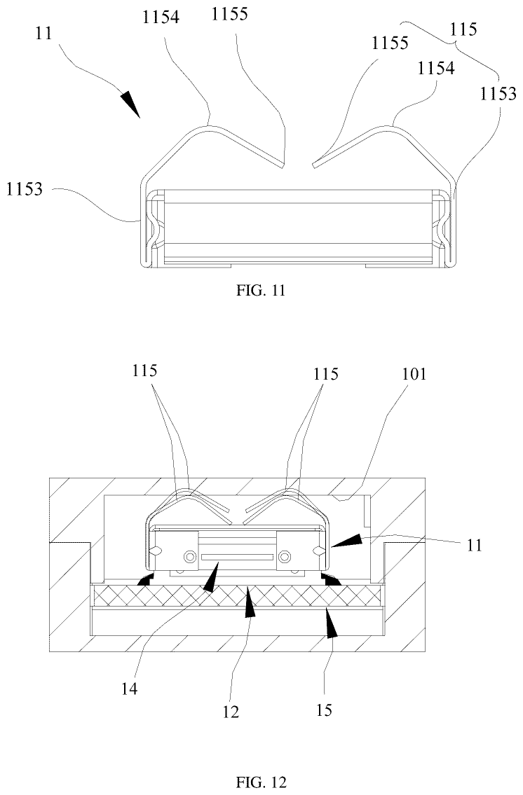

Referring to FIG. 9 to FIG. 12, optionally, the elastic fixation unit 115 comprises a body connection portion 1153 for connecting the fixation body 111, an elastic attaching portion 1155 for fixing with the fixation body 111 in an attaching manner, and a second elastic compression portion 1154 for connecting the body connection portion 1153 and the elastic attaching portion 1155.

The body connection portions 1153 are symmetrically provided on both sides of the fixation body 111.

The second elastic compression portions 1154 are symmetrically provided above the fixation body 111.

In the present embodiment, after the upper housing 101 and the lower housing 102 are closed, the elastic fixation unit is extruded and deformed by the module housing 101, the second elastic compression portion 1154 is tightly attached to an inner surface of the module housing 10, and the elastic attaching portion 1155 is tightly attached with the fixation body 111, so that the elastic fixation unit applies a certain pressure to the fixation body 111 in a direction of the lower housing 102, thereby making the elastic fixation unit, the optical element 12 and the optical fiber connector 13 be more tightly attached in the first direction, and then improving the stability of the fixation between the optical element 12 and the optical fiber connector 13.

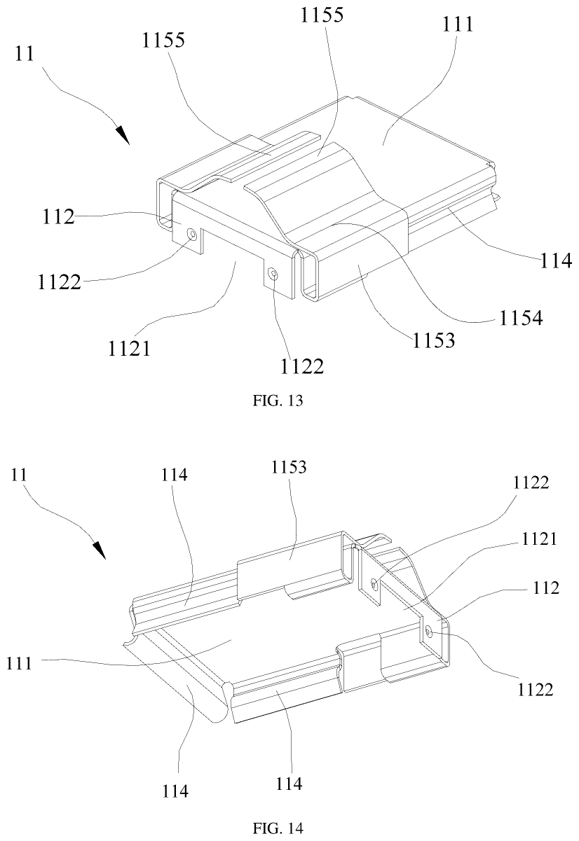

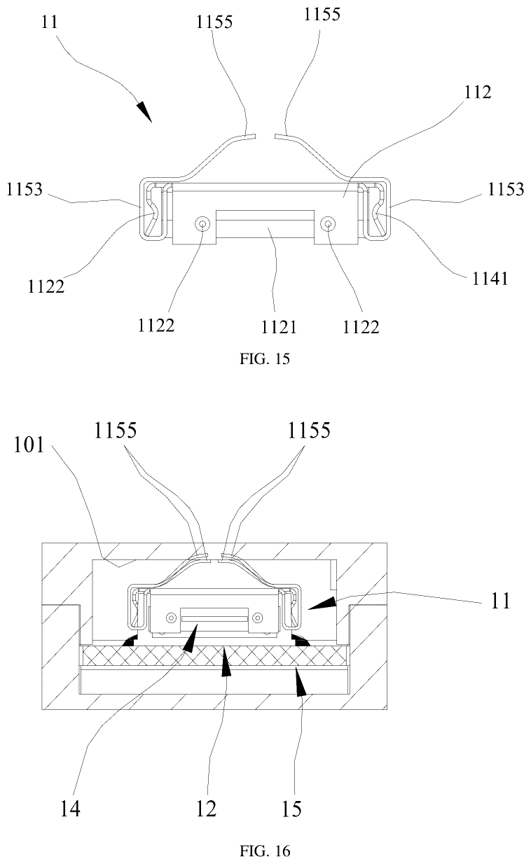

Referring to FIG. 13 to FIG. 16, optionally, the elastic fixation unit 115 comprises a body connection portion 1153 for connecting the fixation body 111, an elastic attaching portion 1155 for fixing with the fixation body 111 in an attaching manner, and a second elastic compression portion 1154 for providing in cooperation with the upper housing 101.

The body connection portions 1153 are symmetrically provided on both sides of the fixation body 111.

The elastic attaching portions 1155 are symmetrically provided above the fixation body 111 and are connected with the body connection portion 1153 and the second elastic compression portion 1154.

In the present embodiment, the elastic fixation unit is extruded and deformed by the module housing 10, the elastic attaching portion 1155 is attached to the fixation body 111, and the second elastic compression portion 1154 is tightly attached to the inner surface of the module housing 10, so that the elastic fixation unit applies a certain pressure to the fixation body 111 in the direction of the lower housing 102, thereby enabling the elastic fixation unit, the optical element 12 and the optical fiber connector 13 to be more tightly attached in the first direction, and then improving the stability of the fixation between the optical element 12 and the optical fiber connector 13.

Referring to FIG. 8, in one embodiment, the first fixation unit 112 is provided with an opening 1121 for accommodating the optical fiber 14; both sides of the opening 1121 are respectively provided with a stuck point 1122, and the corresponding position of the first end 131 of the optical fiber connector is provided with a stuck hole, and then the optical fiber connector 13 is fixed to the first fixation unit 112 through the stuck point 1122 and the stuck hole 133 in a snap-fit manner. In the present embodiment, through the matching of the stuck point 1122 and the stuck hole 133, the optical fiber connector 13 is fixed with the first fixation unit 112 in a snap-fit manner, so that the assembly and disassembly between the optical fiber connector 13 and the first fixation unit 12 are convenient, improving the assembly and disassembly efficiency and the maintenance efficiency, and replacements are convenient when one of the components is damaged, then materials are saved and it is more environmentally friendly.

Referring to FIG. 2 and FIG. 6, in one embodiment, the third fixation unit 114 is provided with a snap-fit portion 1141, and both sides of the optical element 12 are provided with the clamping slot portion 123 corresponding to the snap-fit portion 1141. The optical element 12 is fixed to the third fixation unit 114 through the snap-fit portion 1141 and the clamping slot portion 123 in a snap-fit manner. In the present embodiment, through the matching of the snap-fit portion 1141 and the clamping slot portion 123, the optical element 12 is fixed with the third fixation unit 114 in a snap-fit manner, so that the assembly and disassembly between the optical element 12 and the third fixation unit 114 are convenient, improving the assembly and disassembly efficiency and the maintenance efficiency, and replacements are convenient when one of the components is damaged, thereby saving materials and make it more environmentally friendly.

What has been disclosed above is only the preferred embodiment of the present disclosure, and of course it cannot be used to limit the scope of protection of the present disclosure, therefore, equivalent changes made according to the claims of the present application still fall within the scope of the present disclosure.

1. An optical element fixation structure for fixing an optical element and an optical fiber connector, the optical element being provided with a front-end socket, and the optical fiber connector being provided in the optical element through the front-end socket, wherein the optical element fixation structure comprises:
a module housing which comprises an upper housing and a lower housing;
a fixation body which is provided in the module housing;
a first fixation unit which is provided at a first end of the fixation body, and is used for fixing a first end of the optical fiber connector and a first end of the optical element to the first end of the fixation body in a snap-fit manner;
a second fixation unit which is provided at a second end of the fixation body, and is used for fixing a second end of the optical fiber connector and a second end of the optical element to the second end of the fixation body in an attaching manner;
a third fixation unit which is provided at side edges of the fixation body, and is used for fixing side edges of the optical element to both sides of the fixation body in a snap-fit manner.

2. The optical element fixation structure of claim 1, wherein the optical element fixation structure is a metal piece.

3. The optical element fixation structure of claim 2, wherein the second fixation unit comprises a first connection portion used for connecting other components and a clip-clasp portion used for being fixed with the optical fiber connector in an attaching manner;
the clip-clasp portion and the first connection portion are provided in a bent manner, and the clip-clasp portion is located on a side close to the second end of the fixation body.

4. The optical element fixation structure of claim 3, wherein the optical element fixation structure comprises an elastic fixation unit provided between the fixation body and the upper housing, and the elastic fixation unit is used for defining a degree of freedom of the optical element and the optical fiber connector in an up and down direction.

5. The optical element fixation structure of claim 4, wherein the elastic fixation unit comprises an elastic connection portion for connecting with the first connection portion, and the elastic connection portion and the first connection portion are provided at an acute angle.

6. The optical element fixation structure of claim 5, wherein the elastic fixation unit further comprises a first elastic compression portion, and the first elastic compression portion is connected with the elastic connection portion, and is attached with the upper housing when being compressed.

7. The optical element fixation structure of claim 4, wherein the elastic fixation unit 115 is a wavy metal piece.

8. The optical element fixation structure of claim 4, wherein the elastic fixation unit comprises a body connection portion for connecting the fixation body, an elastic attaching portion for fixing with the fixation body in an attaching manner, and a second elastic compression portion for connecting the body connection portion and the elastic attaching portion;
the body connection portions are symmetrically provided on both sides of the fixation body;
the second elastic compression portions are symmetrically provided above the fixation body.

9. The optical element fixation structure of claim 4, wherein the elastic fixation unit comprises a body connection portion for connecting the fixation body, an elastic attaching portion for being fixed with the fixation body in an attaching manner, and a second elastic compression portion for being provided in cooperation with the upper housing;
the body connection portions are symmetrically provided on both sides of the fixation body.
the elastic attaching portions are symmetrically provided above the fixation body, and are connected with the body connection portion and the second elastic compression portion, respectively.

10. The optical element fixation structure of claim 1, wherein the first fixation unit is provided with an opening for accommodating the optical fiber, both sides of which are respectively provided with a stuck point, a corresponding position of the first end of the optical fiber connector being provided with a stuck hole, and the optical fiber connector is fixed to the first fixation unit through the stuck point and the stuck hole in a snap-fit manner.

11. The optical element fixation structure of claim 1, wherein the third fixation unit is provided with a snap-fit portion, and both sides of the optical element are respectively provided with a clamping slot portion corresponding to the snap-fit portion; the optical element is fixed to the third fixation unit through the snap-fit portion and the clamping slot portion in a snap-fit manner.
